(19) United States
(12) Patent Application Publication
(10) Pub. No.: US 2002/0059576 A1
(43) Pub. Date: May 16, 2002

(54) Metering viewing of video displayed in windows

(76) Inventors: William A. Feininger, Palm Harbor, FL (US); Daozheng Lu, Dunedin, FL (US)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/972,418

(22) Filed: Oct. 5, 2001

Related U.S. Application Data
(63) Continuation-in-part of application No. 09/207,224, filed on Dec. 8, 1998.

(51) Int. Cl. H04N 7/16

(52) U.S. Cl. 725/1; 725/23

(57) ABSTRACT

A metering system useful in metering viewing of video displayed in a window on a screen of a viewing device includes a software meter and a creditor. The software meter determines identifying data related to the video displayed in the window, and the creditor applies a set of crediting rules in determining whether to credit the identifying data. The software meter determines whether the viewing device has a COM interface, an API interface, or has to be interrogated in another way, and determines channel data from a channel related object of the COM interface, from application related data associated with a video application through the API interface, or from other interrogation. The software meter also determines an ancillary identification code relating to the displayed video.

### RELATED APPLICATION

This application is a continuation-in-part of U.S. application Ser. No. 09/207,224 file Dec. 8, 1998.

### TECHNICAL FIELD OF THE INVENTION

The present invention relates to the metering of video, enhanced video containing data elements, and/or broadcast applications displayed in viewing windows of a receiver such as an enhanced television, a television provided with a set top box, a computer, and/or the like.

### BACKGROUND OF THE INVENTION

Video and/or audio played by conventional televisions and/or radios has been metered for many years. One known approach to such metering is to add an ancillary identification code to television and/or radio programs, and to detect and decode the ancillary identification code when the encoded program is viewed or heard in a statistically selected monitoring site. An example of a system which implements this type of metering may be found in the following patents: U.S. Pat. No. 5,481,294 to Thomas et al., who describe, inter alia, ancillary identification codes added to the vertical blanking interval of an NTSC television broadcast; U.S. Pat. No. 5,629,739 to Dougherty, who is particularly concerned with the addition of an ancillary identification code to a low energy portion of the audio spectrum of an NTSC signal; and, U.S. Pat. No. 5,404,377 to Moses, who teaches an audio encoding arrangement using signal masking in order to decrease the perceptibility of the ancillary identification code.

Another approach to metering video and/or audio played by conventional televisions and/or radios is to extract a characteristic signature (or a characteristic signature set) from the program selected for viewing and/or listening, and to compare the characteristic signature (or characteristic signature set) with reference signatures (or reference signature sets) collected from known broadcasting sources. This approach is taught by Lert and Lu in U.S. Pat. No. 4,677,466.

Yet another approach to metering video and/or audio played by conventional televisions and/or radios is to compare the program (or some component or artifact thereof) during playing with all the programs available to a sampled household at the time of playing. A review of apparatus and methods useful for this measurement approach is found in the teachings of Thomas et al. in U.S. Pat. No. 5,629,739 and of Lu et al. in U.S. Pat. No. 5,594,934.

In addition, Wheeler, et al., in U.S. application Ser. No. 08/786,270, filed on Jan. 22, 1997, teach a video signal source detection arrangement which determines the source of a video and/or audio signal being displayed by a television receiver. This detection arrangement implements a variety of tuning measurement approaches. For example, it can be used to read an ancillary identification code transmitted with television programming, to obtain characteristic signatures from television programming, or to perform real time correlation by matching a signal with a contemporary reference signal obtained by a television tuner controlled by measurement equipment.

Also, Chan, in U.S. application Ser. No. 08/654,309, filed on May 28, 1996, teaches a sensor arrangement for non-intrusively obtaining a representation of video and synchronization signals from a television receiver.

The above patents are directed primarily to the metering of conventional receivers where program signals (e.g., television and/or radio signals) are transmitted to receivers over the air, by way of cables, or through satellite distribution. The receivers employ tuners which tune to selected channels from among the various channels offered to the receivers. In the future, however, program signals will be received by receivers which are capable of performing functions in addition to tuning and displaying television and/or radio programs. Such additional functions may include, for example, the reception of IP or HTML, electronic programming guides, electronic commerce, integrated telephony, and/or the like. Such additional functions may also include the offering of Internet access, integrated gaming consoles, and/or the like. Receivers offering these additional functions might be computers, receivers enhanced with internal hardware and/or software, receivers provided with set top boxes which support the additional functions, or the like.

Therefore, broadcasts in the future will likely include a data stream in addition to a video stream and/or an audio stream. The data stream can include closed captioning, program/source ancillary identification codes, electronic programming guides, stock/news/sports tickers, ad banners, chat sessions, story line information, other audio/video streams, and/or other data. The data stream, the video stream, and the audio stream can be transmitted terrestrially, or by cable, or by satellite, or by phone lines.

The sources of broadcasts containing data streams in addition to video streams and/or audio streams could be television stations, radio stations, and Internet servers. For a television or radio broadcast, data can be transmitted by a television or radio station at a known frequency, or as packets within the signal, to which a tuner can tune.

For an Internet broadcast, however, there are at least two possible models. In one model, a page is requested by way of a URL, and the addressed Internet server sends that one requested page and/or stream to the requester. In the other model, an Internet server broadcasts its data by way of multicast IP. A user would connect, or tune, to a multicast IP address in order to receive the broadcast. Many radio stations currently broadcast their programming worldwide on the Internet using a multicast IP address.

A receiver, such as a computer, an enhanced television, an enhanced radio, or a set top box, receives one multi-stream signal from a television station, a radio station, or an Internet server, and demultiplexes the received multi-stream signal into its data stream and its video and/or audio streams. A multi-stream signal from an Internet server can be broken down into separate streams because each object on a page has a tag which can be used to identify the nature of the object. However, it should be noted that, in the context of the Internet, video, audio, and data should be streamed rather than transmitted according to the usual Internet model of store and play. Store and play for broadcast is not possible unless the data is being stored (or recorded) for later playing.

Each stream is passed to a corresponding subsystem of the receiver. For example, the audio stream is passed to a speaker, the video stream is passed to a display screen, and the data stream is passed to appropriate data processing equipment. This data processing equipment can include a data demultiplexer for demultiplexing the data stream into a programming guide, an ancillary identification code, closed captioning, live tickers, and the like, that is further processed by appropriate other components of the data processing equipment.

A meter for metering television and/or radio programs in the context of computers, set top boxes, enhanced televisions, and enhanced audio equipment will be needed in the future.

### SUMMARY OF THE INVENTION

According to one aspect of the present invention, a method of the present invention credits viewing with respect to a viewing window being displayed on a screen. The method comprises the following steps: a) applying a predetermined crediting rule to the viewing window; and, b) crediting viewing with respect to the viewing window only if the viewing window meets the predetermined crediting rule.

According to another aspect of the present invention, a method of metering video displayed in a window on a screen of a viewing device comprises the following steps: a) determining whether the viewing device has a COM interface or an API interface; b) if the viewing device has a COM interface, determining channel data from a channel related object of the COM interface; and, c) if the viewing device has an API interface, calling the API interface so as to determine channel data associated with a video application.

According to still another aspect of the present invention, a software meter is arranged to meter video displayed in a window on a screen of a viewing device, and the software meter is executed by a processor. The software meter comprises first and second program code. The first program code is executable in order to determine tuning data from a video application related to the displayed video. The second program code is executable in order to determine an ancillary identification code relating to displayed video.

According to yet another aspect of the present invention, a metering system meters viewing of video displayed in a window on a screen of a viewing device and comprises a software meter and a creditor. The software meter is arranged to determine identifying data related to the video displayed in the window. The creditor is arranged to apply a crediting rule in determining whether to credit the identifying data.

### BRIEF DESCRIPTION OF THE DRAWING

These and other features and advantages of the present invention will become more apparent from a detailed consideration of the invention when taken in conjunction with the drawings in which:

FIG. 1 illustrates an exemplary distribution system in which programs and data are distributed to panelist sites which are metered in accordance with the present invention;

FIG. 2 is a schematic block diagram showing a representative set of receiving equipment that may be used at the panelist sites of FIG. 1;

FIG. 3 is a schematic block diagram depicting a measurement system that can be used to collect viewing and other data in connection with the present invention;

FIGS. 4 and 5 are flow charts of a program that can be executed by the software meter of FIG. 3 in accordance with the present invention;

FIG. 6 is a flow chart of a program that can be executed by the crediting rules block of FIG. 3 in accordance with the present invention;

FIG. 7 is a flow chart of a program that can be executed by the transmit data block of FIG. 3 in accordance with the present invention; and,

FIGS. 8 and 9 are flow charts of a program that can be executed by the central facility of FIG. 1 in accordance with the present invention.

### DETAILED DESCRIPTION OF THE INVENTION

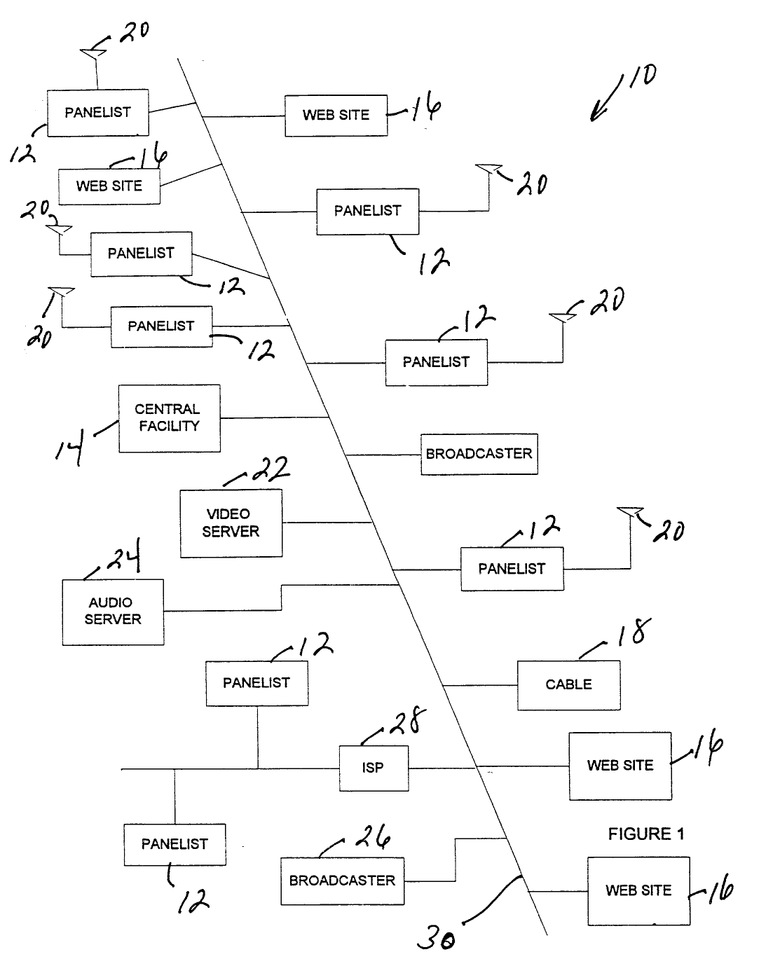

A distribution system 10 is shown in FIG. 1 as an exemplary environment for the present invention. The distribution system 10 includes a plurality of panelist sites 12 statistically selected, such as by a central facility 14, in order to participate in a viewing or listening survey. Accordingly, these statistically selected panelist sites 12 may be collectively referred to as a panel. Personnel at the central facility 14, or elsewhere, may implement random digit dialing, for example, in order to find the panelist sites 12 for participation in the viewing or listening survey as members of the panel. The central facility 14, in some instances, may be referred to as a data collection site.

As described below, the panelist sites 12 include viewing or listening equipment which may be metered in order to determine which programs are being viewed or heard. In all cases, viewing is considered to be viewing of all elements that appear on the screen or played by the speaker. This viewing includes, but is not limited to, the traditional audio/video signal, still images (bitmaps, jpegs, gif's, animated gif's, etc.), text, additional audio/video streams, rotation advertising banners, data entry controls (edit boxes, buttons, etc.), broadcast applications, and hyperlinks associated with any of these elements. In order to simplify the discussion below, viewing data and listening data may alternatively be referred to as media data, it being understood that the present invention may be used to meter video viewing and/or audio listening. Media data collected at each of the panelist sites 12 may be transmitted to the central facility 14 where the data can be assembled into reports for dissemination to interested parties, as is discussed more fully below.

Video, audio, and data may be provided to the panelists by Web sites 16, by a cable source 18, from broadcasters over the air through antennas 20, by a video server 22, by an audio server 24, by broadcasters 26, or the like. As shown in FIG. 1, one or more of the panelists 12 may reach the video, audio, and data through an Internet Service Provider 28. The panelist sites 12, the central facility 14, the Web sites 16, the cable source 18, the video server 22, the audio server 24, the broadcasters 26, and the Internet Service Provider 28 may be interconnected by a network 30 which, for example, may be a public telephone system, an internal network, a cable system, a combination of a public telephone system, an internal network, a cable system, or the like.

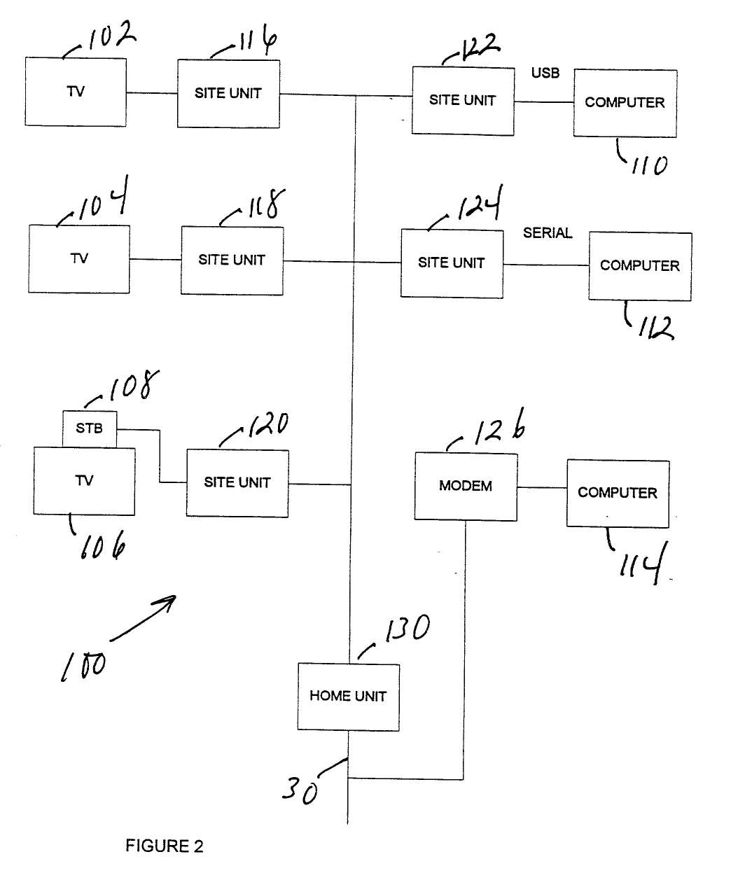

A representative panelist site 100 is shown in FIG. 2 and can include any combination of the equipment shown therein depending upon the number and kind of receivers owned by the panel members thereat. For example, the panelist site 100 may include televisions 102 and 104 which may be televisions enhanced with hardware and/or software permitting them to process a data stream in addition to a video stream and an audio stream. The panelist site 100 also may include a television 106 equipped with a set top box 108 that permits the television 106 to be used with a data stream in addition to a video stream and an audio stream. In addition, the panelist site 100 may include computers 110, 112, and 114.

In current metering equipment installed by the assignee of the present invention and used to meter conventional receivers, site units and a home unit are typically provided in a dwelling occupied by a panel member. The number of site units that are provided in a dwelling depends on the number of meterable receivers used by the occupants of that dwelling. Accordingly, a site unit is provided for each metered receiver, and all of the site units in the dwelling are coupled to the home unit. The site units meter their corresponding receivers and pass the metered data to the home unit. The home unit assembles and stores the metered data from each of the site units and then forwards that assembled and stored data to the central facility 14. For example, the home unit may be arranged with dial out capability to dial out to the central facility at a predetermined time or interval during the day. Alternatively, the home unit may respond to polling messages from the central facility in order to provide the metered data accumulated from the site units to the central facility in response to the polling messages.

Accordingly, a site unit 116 is provided for the television 102, a site unit 118 is provided for the television 104, a site unit 120 is provided for the set top box 108, a site unit 122 is provided for the computer 110, and a site unit 124 is provided for the computer 112. Additionally, a modem 126 is provided for the computer 114. The site units 116, 118, 120, 122, and 124 are suitably coupled to a home unit 130 which in turn is coupled to the network 30. The modem 126 is directly coupled to the network 30. With this arrangement, the home unit 130, in addition to assembling, storing, and forwarding metered data to the central facility 14, also passes the video, audio, and data streams from the network 30 through the site units 116, 118, 120, 122, and 124 to the televisions 102 and 104, to the set top box 108, and to the computers 110 and 112.

In accordance with the present invention, the site units 116, 118, 120, 122, and 124 may each implement a measurement system 150 described below in order to meter tuning and other activities with respect to their corresponding receiving equipment. Also, because the computer 114 is capable of implementing the measurement system 150, the computer 114 does not require a site unit and may communicate directly with the central facility 14 through the network 30. Indeed, depending upon the capabilities of the televisions 102 and 104, the set top box 108, and the computers 110 and 112, the site units 116, 118, 120, 122, and 124 may be eliminated and the televisions 102 and 104, the set top box 108, and the computers 110 and 112 may each implement the measurement system 150. In this case, the home unit 130 may also be eliminated. However, it should be noted that, if the home unit 130 is eliminated, the number of units interacting directly with the central facility 14 increases dramatically. Alternatively, the site units 116, 118, 120, 122, and 124 may be retained even though the televisions 102 and 104, the set top box 108, and the computers 110 and 112 each implement the measurement system 150. In this case, the site units 116, 118, 120, 122, and 124 may simply perform the function of collecting metered data for forwarding to the home unit 130 or to the central facility 14 directly.

As shown in FIG. 2, it is assumed that the computer 110 has a universal serial bus (USB) to which the site unit 122 is connected, and that the computer 112 has a serial port to which the site unit 124 is connected. However, it should be noted that connection types other than, or in addition to, a universal serial bus and a serial port may be used with the present invention.

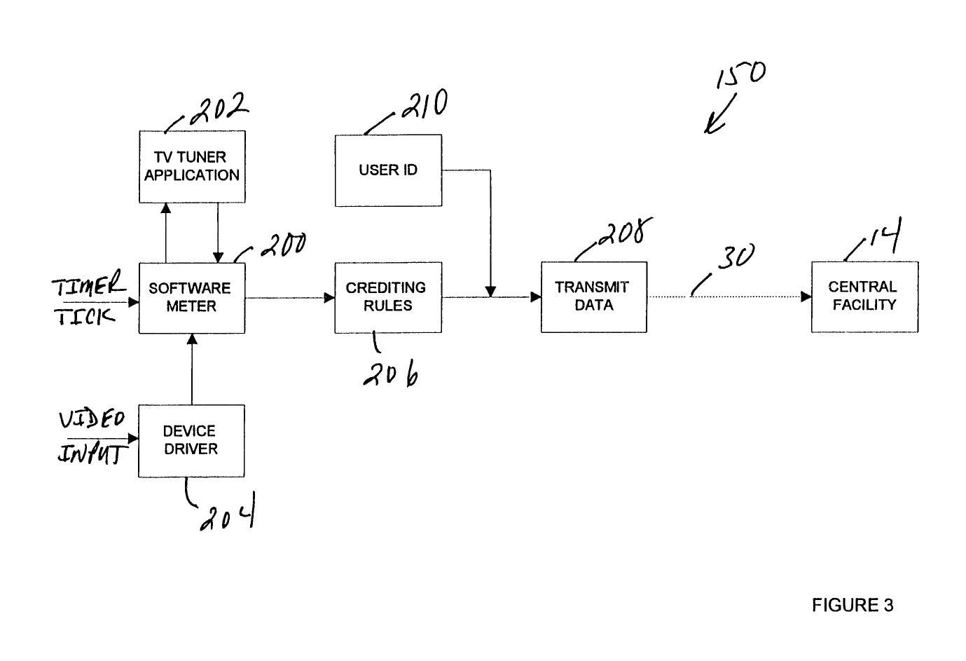

As shown in FIG. 3, the measurement system 150 includes a software meter 200 that periodically interrogates a television tuner application 202 (such as WebTV for the Windows viewer application of Windows 98™) in order to determine channel and other information with respect to a program, or other data content being displayed on a display screen within a viewing window or windows. Operation of the software meter 200 may be initiated in response to a timer tick as shown, upon suitable notification supplied to the software meter 202, or the like. The television tuner application 202, for example, runs under a Windows-based operating system on each of the televisions 102 and 104, the set top box 108, and the computers 110, 112, and 114. The software meter 200 receives channel information from the television tuner application 202. The software meter 200 also receives other information either from the television tuner application 202 or from operating system messages. This other information can include size, occlusion, and position information for all video and data objects relative to the viewing window. Alternatively, or additionally, the software meter 200 can receive ancillary identification codes from a device driver 204 in those instances where an ancillary identification code is transmitted along with programs and data to the panelist sites 12.

The channel and other information are passed to a crediting rules block 206 which applies a set of crediting rules to the channel and other information in order to determine whether the channel and other information should be credited. A transmit block 208 forwards the credited channel and other information directly to the central facility 14 over the network 30. Alternatively, the transmit block 208 may be arranged to forward the credited channel and other information to the home unit 130 for later transmission to the central facility 14.

In addition, the transmit block 208 receives user ID information from a user ID block 210. A conventional Nielsen Media Research (NMR) PeopleMeter can be used for the user ID block 210 and can be attached to a corresponding site unit or computer. The user logs in by pressing a personal identifying button or pad on the NMR PeopleMeter. Alternatively, the software meter 200 itself could be arranged to prompt the user to enter the user's identification when the user is using a computer or a television enhanced with a manual input capability. In this connection, when the user ID block 210 detects inactivity (such as no keyboard activity or mouse click) for a specified period of time, the user ID block 210 may be arranged to prompt the user in order to determine if the user is still using the receiver. Similarly, the user ID block 210 may be arranged to prompt a viewer to enter the viewers identification upon channel changes. Other alternatives for the user ID block 210, such as a passive identification device, or a voice or image recognition device, are possible.

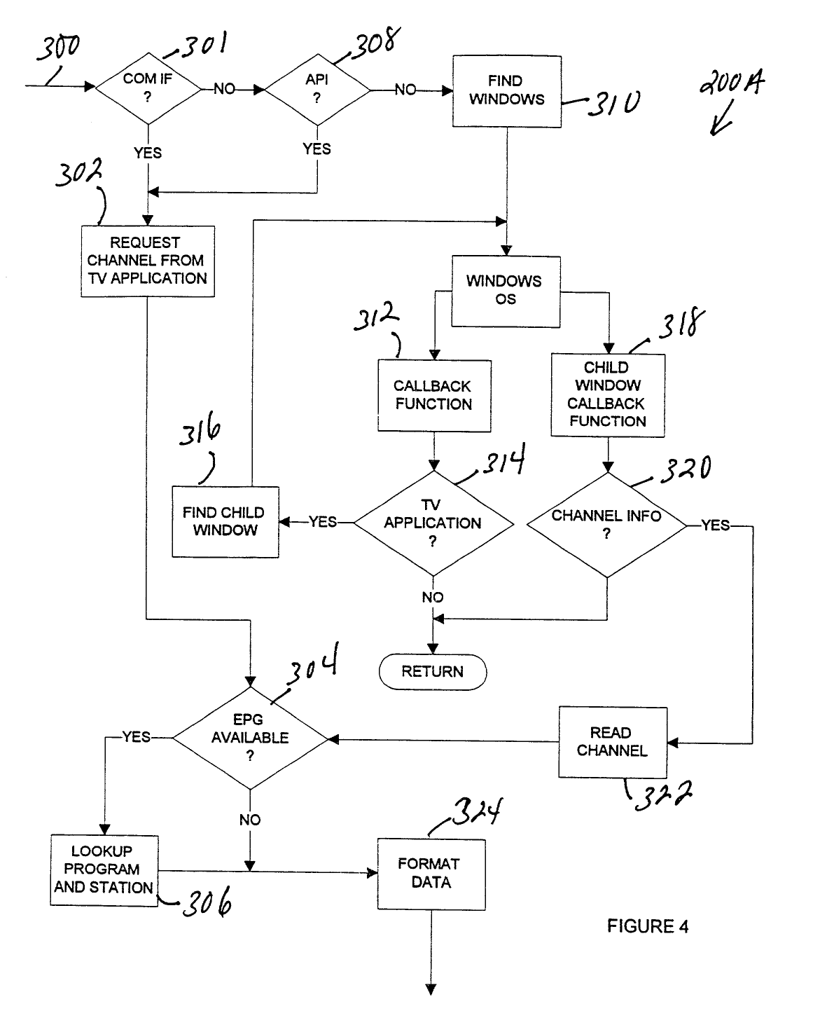

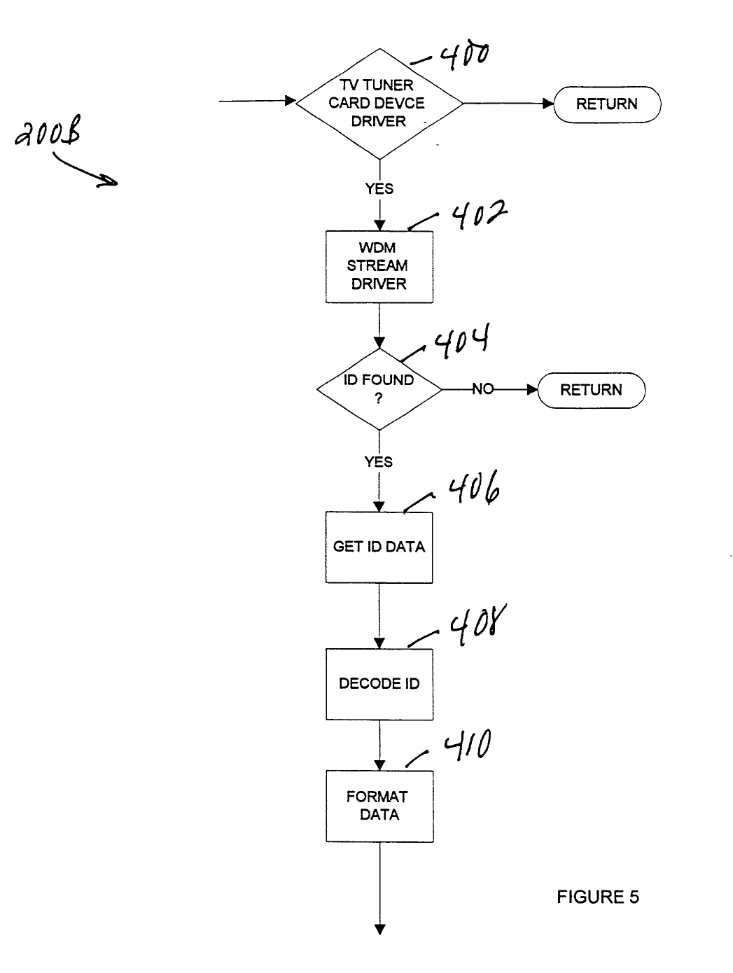

A flow chart representing a program that may be executed by the software meter 200 is shown in FIGS. 4 and 5. As shown in FIG. 4, a first portion 200A of the software meter 200 is executed in order to derive particular data relating to channel, size of the viewing window, position of the viewing window, occlusion of the viewing window, and the like for forwarding to the crediting rules block 206.

Accordingly, in response to a timer tick 300, a channel change event, and/or similar action, the first portion 200A at a block 301 determines whether the television tuner application 202 has a COM interface. For example, the Windows 98™ Web TV for Windows viewer application is comprised of COM objects. Each COM object has a public interface which may be queried for state information. One of these interfaces is “GetCurrentChannel.” This interface provides current tuned channel information of a corresponding television receiver. Accordingly, the software meter 200 at a block 302 periodically invokes the appropriate COM object in order to determine if the corresponding tuner has changed channels. If the channel has changed, the new channel is noted at the block 302 and processing continues. (Although not shown in FIG. 4, if the channel has not changed, the first portion 200A may be arranged to return to the block 301 after an appropriate wait period.)

If the channel has changed, the first portion 200A at the block 302 may also be arranged to obtain other appropriate information. For example, the first portion 200A may be arranged at the block 302 to construct an SQL query in order to request program and channel names for the new channel from an accompanying Microsoft Access database. The first portion 200A is likewise arranged at the block 302 to construct other queries in order to obtain other information such as size of the viewing window, position of the viewing window, occlusion of the viewing window, and the like. Thereafter, the first portion 200A at a block 304 determines whether an electronic programming guide is available with respect to the receiver being metered. If an electronic programming guide is available, the station and/or program names are retrieved from the electronic programming guide at a block 306 based upon the detected channel.

If the television tuner application 202 does not have a COM interface as determined at the block 301, the first portion 200A at a block 308 determines whether the television tuner application 202 has a known application programming interface (API), which is a callable function. If the television tuner application 202 has a known API, calling it directly will return the current channel. Also, the first portion 200A may be arranged at the block 302 to request the other information discussed above, and the functions of the blocks 304 and 306 are invoked.

Some applications, such as Intel's Intercast application, have neither a COM interface nor a known API. Therefore, another process must be invoked. For example, Microsoft supplies the ToolHelp library which allows an application to look at processes, windows, threads, and memory buffers that are running or allocated at any given time. Accordingly, the first portion 200A at a block 310 may be arranged to monitor system messages sent from the operating system in order to look for particular processes, modules, threads, tasks, windows, or components. In this manner, channel information, position of the viewing window, size of the viewing window, occlusion of the viewing window, and the like, may be determined.

Thus, the software meter 200 at the block 310 locates the windows which are being displayed on the corresponding display screen. Then, a callback function is provided at a block 312 to the Windows operating system in order to receive each of the main window handles of all of the processes currently running. Thus, the callback function provided at the block 312 obtains the text of each window handle, by calling the window control “GetWindowText.” The first portion 200A of the software meter 200 at a block 314 looks for a television application from among the window handles obtained at the block 312. If there is no window handle indicating a television application, it is assumed that no television program is currently being tuned and program flow, therefore, returns to the block 301 after an appropriate wait period.

However, if the target television application is found at the block 314, the first portion 200A at a block 316 then locates the child windows associated with the television application found at the block 314. The child windows are subjected to essentially the same processing. Thus, the first portion 200A at a block 318 provides a callback function in order to investigate the handles of each of the child windows of the specified process. Accordingly, the window control callback function provided at the block 318 obtains the text of each child window handle. The first portion 200A at a block 320 determines whether one of the window handles indicates that the corresponding window contains channel information. If one of the child windows contains channel information, that channel information is read at a block 322. The processing at the blocks 312-322 can also be used to obtain other information such as position of the viewing window, size of the viewing window, occlusion of the viewing window, and the like.

The channel information read at the block 322 is provided to the block 304. Accordingly, if an electronic programming guide is available, the channel information read at the block 322 is used to look up program and station names from the electronic programming guide.

If no electronic programming guide is available as determined at the block 304, or if an electronic programming guide is available and program and station information can be derived therefrom, the channel, program, station, and/or other information are formatted at a block 324 and the formatted information is provided to the crediting rules block 206.

A second portion 200B of the software meter 200 is shown in FIG. 5. This second portion 200B may be entered from the block 324. If this second portion 200B is entered from the block 324, and if a television tuner card device driver is not provided with the receiver associated with the software meter 200 as determined at a block 400, program flow returns to the block 301 after an appropriate wait period. However, assuming that a television tuner card device driver is provided with the receiver associated with the software meter 200, each frame of video data is accepted by the driver. The VBI (vertical blanking interval) of each frame is digitized at the block 400, and the digitized VBI is sent to a WDM stream driver 402. The second portion 200B at a block 404 investigates the VBI stream in order to determine whether the VBI stream contains an ancillary identification code. Ancillary identification codes are frequently provided by broadcasters in the vertical blanking intervals of programs. If no ancillary identification code is found, the second portion 200B returns to the block 301 after an appropriate wait period. On the other hand, if an ancillary identification code is found, then the ancillary identification code is extracted at a block 406 and is decoded at a block 408. Thereafter, the ancillary identification code is formatted and sent to the crediting rules block 206 along with the channel, program, station, and/or other information formatted at the block 324.

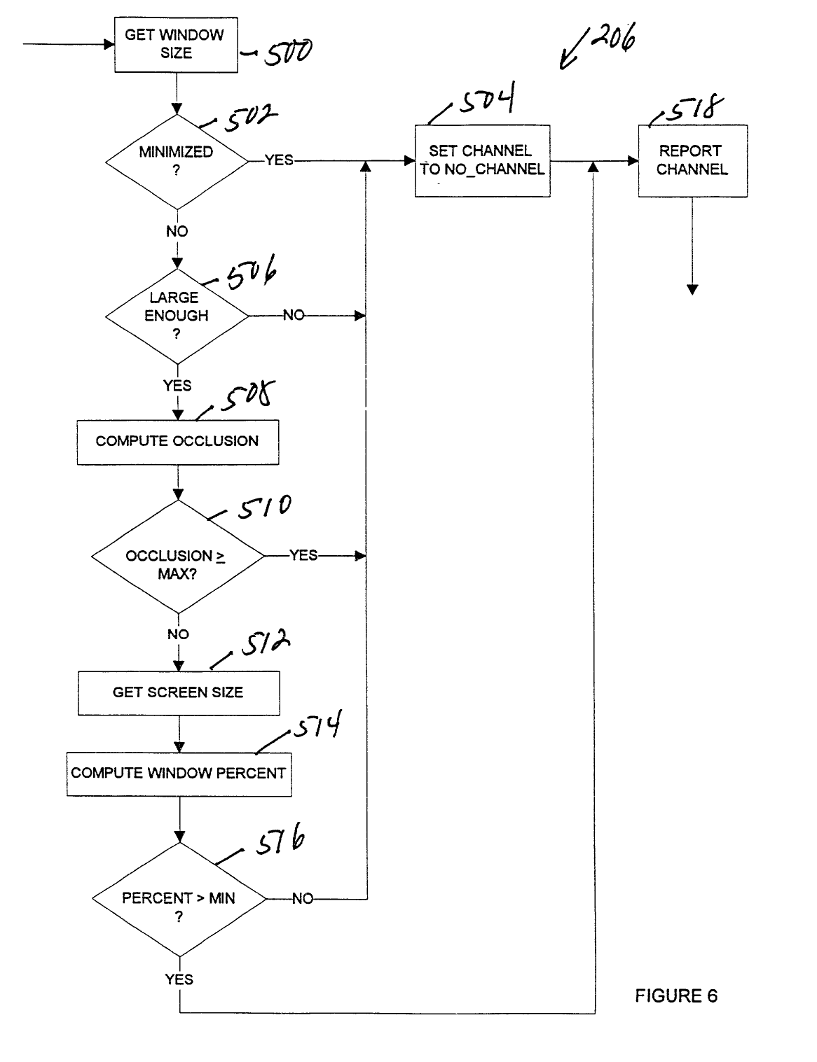

The crediting rules block 206 is shown in FIG. 6. The size of a viewing window containing a television program is obtained at a block 500. A first rule (or criteria) that is applied by the crediting rules block 206 at a block 502 relates to minimization of the viewing window containing a television program. According to this rule, if this viewing window has been minimized, then viewing is not credited and, instead, the channel is set to NO_CHANNEL at a block 504. On the other hand, if the viewing window has not been minimized, a second rule is applied at a block 506. This second rule relates to size of the viewing window containing a television program. According to this rule, if the size of the viewing window fails to meet a minimum window size requirement as determined at the block 506, the channel is set to NO_CHANNEL at the block 504.

If the size of this viewing window meets the minimum window size requirement, a third rule relating to window occlusion is applied. In order to apply this third rule, the amount of window occlusion (i.e., the amount by which another window overlaps and occludes a viewing window containing a television program) is computed at a block 508. A block 510 implements the third rule by comparing the amount of window occlusion computed at the block 508 to a predetermined maximum amount of window occlusion. If the amount of window occlusion computed at the block 508 is greater that the predetermined maximum amount of window occlusion, the channel is set to NO_CHANNEL at the block 504.

However, if the amount of window occlusion computed at the block 508 is not greater that the predetermined maximum amount of window occlusion, a fourth rule relating to the percent of the display screen filled by a viewing window containing a television program is applied. In order to apply this fourth rule, the size of the display screen is obtained at a block 512, and a percent of this display screen size occupied by the viewing window containing the television program is computed at a block 514. A block 516 implements the fourth rule by comparing the percent computed at the block 514 to a predetermined minimum percent. If the percent of the display screen occupied by the viewing window containing a television program is not greater than the predetermined minimum percent, the channel is set to NO_CHANNEL at the block 504. On the other hand, if the window containing a television program has not been minimized as determined by the block 502, if the size of this viewing window meets a minimum window size requirement as determined at the block 506, if the amount of window occlusion computed at the block 508 is not greater than the predetermined maximum amount of window occlusion as determined at the block 510, and if the percent of the display screen occupied by the viewing window containing the television program is greater than the predetermined minimum percent as determined at the block 516, the channel is not set to NO_CHANNEL and, instead, the channel (and other information) associated with the program displayed in the program viewing window is reported at a block 518 to the transmit block 208.

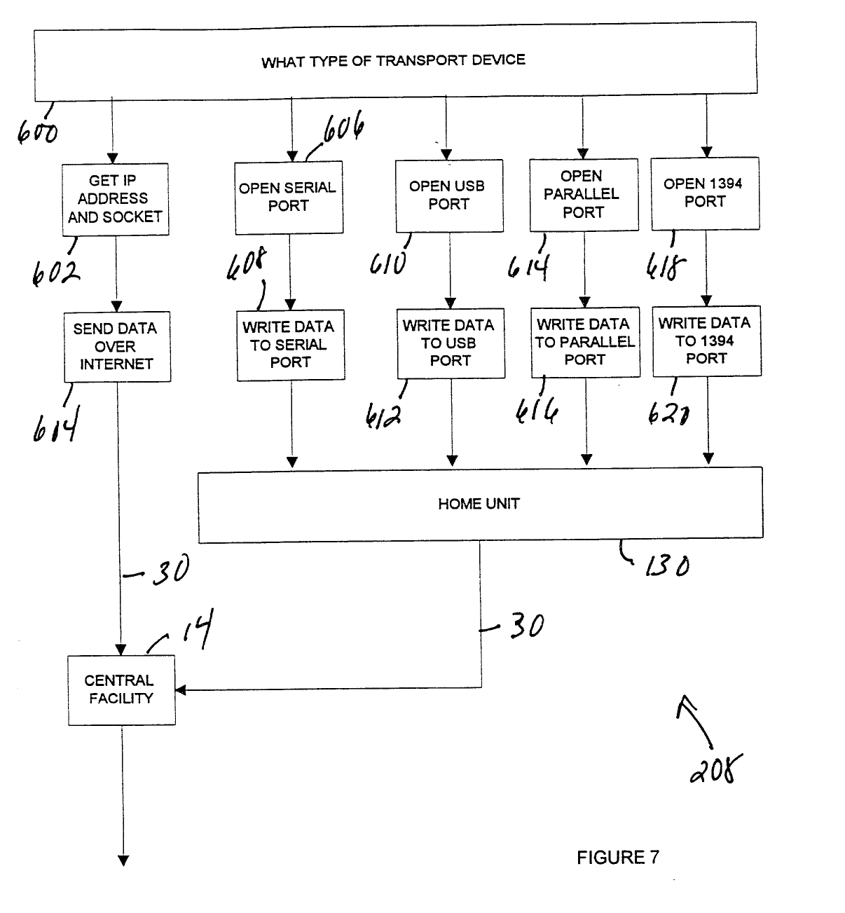

The transmit block 208 is shown in FIG. 7. The path over which the channel and other information is reported to the central facility 14 depends upon the type of port which is available. Accordingly, the type of transport device is determined at a block 600. Thus, the transmit block 208 determines what method of data transmission to use. If the transport is by way of TCP/IP as determined at a block 602, the transmit block 208 obtains from memory the IP address of the server at the central facility 14 as well as the socket on which this server is listening. The data is then encrypted and transmitted to the server at the central facility 14 at a block 604. Accordingly, this method collects and transmits data in “near” real time.

If the transport is to the home unit 130 over a serial port, the serial port is opened at a block 606 and the appropriate data is written to the serial port at a block 608 for supply to the home unit 130. If the transport is to the home unit 130 over a USB port, the USB port is opened at a block 610 and the appropriate data is written to the USB port at a block 612 for supply to the home unit 130. If the transport is to the home unit 130 over a parallel port, the parallel port is opened at a block 614 and the appropriate data is written to the parallel port at a block 616 for supply to the home unit 130. If the transport is to the home unit 130 over a 1394 port, the 1394 port is opened at a block 618 and the appropriate data is written to the 1394 port at a block 620 for supply to the home unit 130. The transmit block 208 can also send data to the home unit 130 by way of power lines or an RF modem.

Perhaps the most efficient way currently to transmit data to the collection facility 14 is by way of the Internet. Personal computers running any version of Windows™ have a component referred to as Winsock which can send and receive data over the Internet. If the user is on-line, the data collected by the software meter 200 can be sent in real time. For devices that are not permanently connected, a store and forward method buffers the data and sends it when a connection is made, or to the home unit 130 which forwards data to the central facility 14 at a later time. In the case of a set top box that does not have a back channel, or a computer that does not have a modem, the data may be sent out over a serial port, a USB port, a parallel port, a 1394 port, or the like, using the DSS command set and/or NUB protocol to a corresponding site unit or directly to the home unit.

The data transmitted by the transmit block 208 may comprise any of the following: household identifiers; device identifiers; viewer IDs; date/time stamps; and, specific viewed data such as an URL, a program ID, a source ID, a station name, a program name, program ID codes, signatures taken from the viewed program, game information, PC/STB configuration information, advertisement banners, viewing area information, and the like.

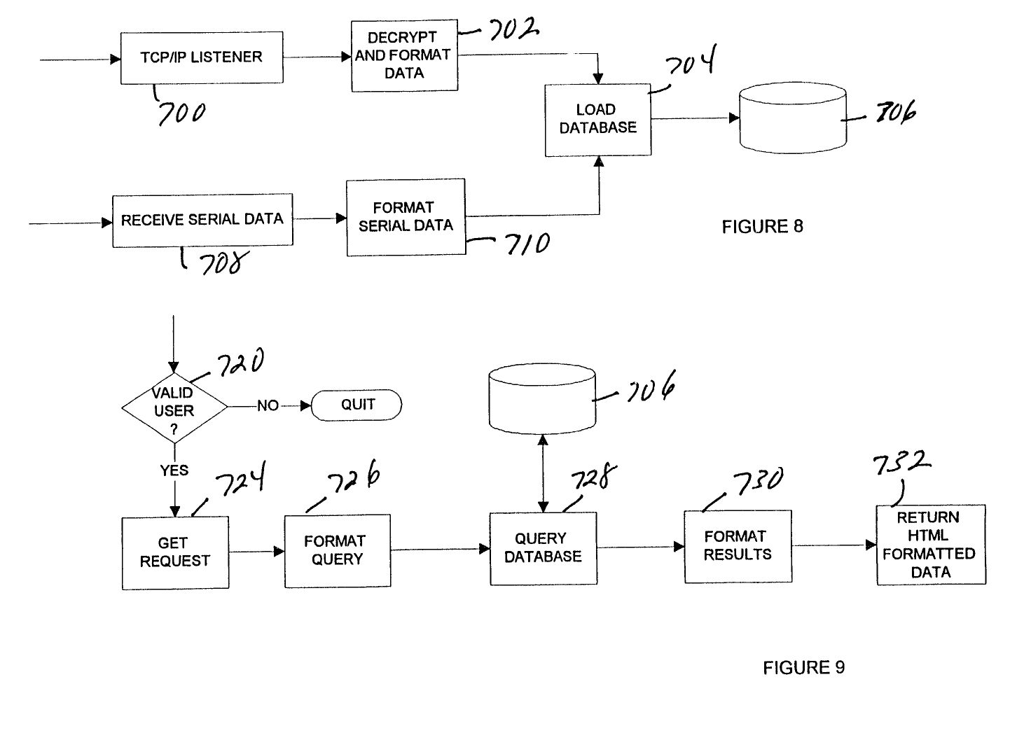

The server at the central facility 14 performs at least a data collection function and a data dissemination function as shown in FIGS. 8 and 9, respectively. As shown in FIG. 8, the data collection function receives data at a TCP/IP listener block 700 in the case of data transmitted by way of the Internet. This received data is validated/authenticated, decrypted, and formatted at a block 702. The data is then loaded by a data loader 704 into a database 706. For serial data, the serial data comes in through a modem at a block 708 and is formatted at a block 710. This data is loaded by the database loader 704 into the database 706.

When a customer requests a report from the central facility 14, the request may come in over the Internet as an HTTP request made by typing a URL into a browser. When the request is received by the central facility 14, the customer is validated at a block 720 by checking the customers log-on ID and password. If the log-on ID and password provided by the customer do not agree, the customer does not receive the requested report. On the other hand, if the customer has entered a proper combination of a log-on ID and a password so that the customer is provided access to the database 706, a short form is presented to the customer at a block 724 in order to gather the information necessary to the inquiry posed by the customer. This inquiry is formatted at a block 726 and is used at a block 728 to query the database 706 and to extract the requested information therefrom. This information is properly formatted into a report at a block 730 and the report is returned to the customer at a block 732. For example, the report may be returned as HTML formatted data.

Certain modifications of the present invention have been discussed above. Other modifications will occur to those practicing in the art of the present invention. For example, as described above, the software meter 200 may respond to a timer tick in order to interrogate the television tuner application 202. Instead, the software meter 200 may be arranged to monitor operating system messages in order to detect channel and other relevant information.

Also, the metering described above is performed by the software meter 200. Instead, the metering may be performed by hardware or by a combination of hardware and software. Similarly, the crediting described above is performed by software implemented by the crediting rules block 206. Instead, the crediting may be performed by hardware or by a combination of hardware and software. The transmit block 208 may be likewise arranged.

Additionally, if a receiver is provided with plural tuners, programs in plural windows may be displayed for viewing and/or listening. In this case, the present invention may be arranged to meter each such viewing window.

Moreover, as described above, certain crediting rules are applied by the crediting rules block 206. In addition, if there are two or more viewing windows, the crediting rules block 206 may be arranged to credit viewing only with respect to the viewing window associated with the audio supplied to the speakers of the receiver, with the size of the viewing window, with the and/or order of the viewing window, or the like.

Furthermore, the software represented by the flow charts disclosed herein and described above may be written in Java so that the software is essentially hardware independent.

Also, as described above, the crediting rules applied by the block 206 are implemented at the panelist site 100 as part of the measurement system 150 which may be installed in the television 102, in the television 104, in the set top box 108, in the computer 110, in the computer 112, in the site unit 116, in the site unit 118, in the site unit 120, in the site unit 122, in the site unit 124, and/or in the computer 114. However, the crediting rules may instead be applied at the central facility 14 or at another site remote from both the central facility 14 and the panelist site 100. Alternatively, a first portion of the crediting rules 206 may be applied at the panelist site 100 and a second portion of the crediting rules 206 may be applied at the central facility 14. As a further alternative, a first portion of the crediting rules 206 may be applied at the panelist site 100 and a second portion of the crediting rules 206 may be applied at a site which is remote from both the panelist site 100 and the central facility 14. As a still further alternative, a first portion of the crediting rules 206 may be applied at the central facility 14 and a second portion of the crediting rules 206 may be applied at a site which is remote from both the panelist site 100 and the central facility 14. As another alternative, a first portion of the crediting rules 206 may be applied at the panelist site 100, a second portion of the crediting rules 206 may be applied at the central facility 14, and a third portion of the crediting rules 206 may be applied at a site which is remote from both the panelist site 100 and the central facility 14.

Also, FIG. 6 shows certain crediting rules that can be applied to the data gathered by the measurement system 150. It should be evident, however, that the block 206 may apply fewer or additional crediting rules.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method of crediting viewing with respect to a viewing window being displayed on a screen, wherein the viewing window has a size, wherein the screen has a size, and wherein the method comprises the following steps:
a) applying a predetermined crediting rule to the viewing window; and,
b) crediting viewing with respect to the viewing window only if the viewing window meets the predetermined crediting rule.

2. The method of claim 1 wherein the predetermined crediting rule applied in step a) comprises minimization, and wherein step b) comprises the step of crediting viewing with respect to the viewing window only if the viewing window is not minimized.

3. The method of claim 1 wherein the predetermined crediting rule applied in step a) comprises minimum window size, and wherein step b) comprises the step of crediting viewing with respect to the viewing window only if the size of the viewing window is greater than the minimum window size.

4. The method of claim 1 wherein the predetermined crediting rule applied in step a) comprises an amount of occlusion of the viewing window, and wherein step b) comprises the step of crediting viewing with respect to the viewing window only if the amount of occlusion of the viewing window is less than a maximum occlusion.

5. The method of claim 1 wherein the predetermined crediting rule applied in step a) comprises a percentage of the screen occupied by the viewing window, and wherein step b) comprises the step of crediting viewing with respect to the viewing window only if the percentage of the screen occupied by the viewing window is greater than a minimum percentage.

6. The method of claim 1 wherein the viewing window is a first viewing window, wherein a second viewing window is displayed on the screen, wherein audio is being played with respect to one of the first and second viewing windows, and wherein step b) comprises the step of crediting viewing only with respect to the one of the first and second viewing windows associated with the audio.

7. The method of claim 1 wherein the viewing window is a first viewing window, wherein a second viewing window is displayed on the screen, wherein one of the first and second viewing windows is larger, and wherein step b) comprises the step of crediting viewing only with respect to the larger of the first and second viewing windows.

8. The method of claim 1 wherein the viewing window is a first viewing window, wherein a second viewing window is displayed on the screen, wherein one of the first and second viewing windows is a top-most viewing window, and wherein step b) comprises the step of crediting viewing only with respect to the top-most viewing window.

9. The method of claim 1 wherein the predetermined crediting rule applied in step a) comprises minimization and minimum window size, and wherein step b) comprises the step of crediting viewing with respect to the viewing window only if the viewing window is not minimized and the size of the viewing window is greater than the minimum window size.

10. The method of claim 1 wherein the predetermined crediting rule applied in step a) comprises minimization and amount of occlusion of the viewing window, and wherein step b) comprises the step of crediting viewing with respect to the viewing window only if the viewing window is not minimized and the amount of occlusion of the viewing window is less than a maximum occlusion.

11. The method of claim 1 wherein the predetermined crediting rule applied in step a) comprises minimization and a percentage of the screen occupied by the viewing window, and wherein step b) comprises the step of crediting viewing with respect to the viewing window only if the viewing window is not minimized and the percentage of the screen occupied by the viewing window is greater than a minimum percentage.

12. The method of claim 1 wherein the predetermined crediting rule applied in step a) comprises minimum window size and an amount of occlusion of the viewing window, and wherein step b) comprises the step of crediting viewing with respect to the viewing window only if the size of the viewing window is greater than the minimum window size and the amount of occlusion of the viewing window is less than a maximum occlusion.

13. The method of claim 1 wherein the predetermined crediting rule applied in step a) comprises minimum window size and a percentage of the screen occupied by the viewing window, and wherein step b) comprises the step of crediting viewing with respect to the viewing window only if the size of the viewing window is greater than the minimum window size and the percentage of the screen occupied by the viewing window is greater than a minimum percentage.

14. The method of claim 1 wherein the predetermined crediting rule applied in step a) comprises an amount of occlusion of the viewing window and a percentage of the screen occupied by the viewing window, and wherein step b) comprises the step of crediting viewing with respect to the viewing window only if the amount of occlusion of the viewing window is less than a maximum occlusion and the percentage of the screen occupied by the viewing window is greater than a minimum percentage.

15. The method of claim 1 wherein the predetermined crediting rule applied in step a) comprises minimization, minimum window size, and an amount of occlusion of the viewing window, and wherein step b) comprises the step of crediting viewing with respect to the viewing window only if the viewing window is not minimized and the size of the viewing window is greater than the minimum window size and the amount of occlusion of the viewing window is less than a maximum occlusion.

16. The method of claim 1 wherein the predetermined crediting rule applied in step a) comprises minimization, minimum window size, and a percentage of the screen occupied by the viewing window, and wherein step b) comprises the step of crediting viewing with respect to the viewing window only if the viewing window is not minimized and the size of the viewing window is greater than the minimum window size and the percentage of the screen occupied by the viewing window is greater than a minimum percentage.

17. The method of claim 1 wherein the predetermined crediting rule applied in step a) comprises minimum window size, an amount of occlusion of the viewing window, and a percentage of the screen occupied by the viewing window, and wherein step b) comprises the step of crediting viewing with respect to the viewing window only if the size of the viewing window is greater than the minimum window size and the amount of occlusion of the viewing window is less than a maximum occlusion and the percentage of the screen occupied by the viewing window is greater than a minimum percentage.

18. The method of claim 1 wherein the predetermined crediting rule applied in step a) comprises minimization, an amount of occlusion of the viewing window, and a percentage of the screen occupied by the viewing window, and wherein step b) comprises the step of crediting viewing with respect to the viewing window only if the viewing window is not minimized and the amount of occlusion of the viewing window is less than a maximum occlusion and the percentage of the screen occupied by the viewing window is greater than a minimum percentage.

19. The method of claim 1 wherein the predetermined crediting rule applied in step a) comprises minimization, minimum window size, an amount of occlusion of the viewing window, and a percentage of the screen occupied by the viewing window, and wherein step b) comprises the step of crediting viewing with respect to the viewing window only if the viewing window is not minimized and the size of the viewing window is greater than the minimum window size and the amount of occlusion of the viewing window is less than a maximum occlusion and the percentage of the screen occupied by the viewing window is greater than a minimum percentage.

20. The method of claim 1 wherein steps a) and b) are implemented by software written in Java.

21. The method of claim 1 wherein the crediting rule is applied at a panelist site.

22. The method of claim 1 wherein the crediting rule is applied at a site remote from a panelist site.

23. The method of claim 1 wherein a first portion of the crediting rule is applied at a panelist site, and wherein a second portion of the crediting rule is applied at a site remote from the panelist site.

24. A method of metering video displayed in a window on a screen of a viewing device comprising the following steps:
a) determining whether the viewing device has a COM interface or an API interface;
b) if the viewing device has a COM interface, determining channel data from a channel related object of the COM interface; and,
c) if the viewing device has an API interface, calling the API interface so as to determine channel data associated with a video application.

25. The method of claim 24 comprising the further following step:
d) determining a program and/or station from an electronic programming guide based upon the channel data determined in step b) or c).

26. The method of claim 24 comprising the further following step:
d) if the viewing device has neither a COM interface nor an API interface, determining channel data from window controls within a viewing application.

27. The method of claim 26 comprising the further following step:
e) determining a program and/or station from an electronic programming guide based upon the channel data determined in step b) or c).

28. The method of claim 26 comprising the further following steps:
e) finding main windows;
f) finding a video application main window from the main windows found in step e);
g) finding child windows of the video application main window found in step f);
h) finding a channel related child window from the child windows found in step g); and,
i) determining channel data from the channel related child window found in step h).

29. The method of claim 28 wherein step f) comprises the following step:
using a callback function to find the video application main window from the main windows.

30. The method of claim 28 wherein step h) comprises the following step:
using a callback function to find the channel related child window.

31. The method of claim 28 comprising the further following step:
determining a program and/or station from an electronic programming guide based upon the channel data determined in step i).

32. The method of claim 24 wherein the viewing device is a computer.

33. The method of claim 24 wherein the viewing device is a television.

34. The method of claim 24 wherein the viewing device is a combination of a television and a set top box.

35. The method of claim 24 wherein steps a), b), and c) are implemented by software written in Java.

36. A software meter arranged to meter video displayed in a window on a screen of a viewing device, the software meter being executed by a processor, the software meter comprising:
a) first program code executable to determine tuning data from a video application related to the displayed video; and,
b) second program code executable to determine an ancillary identification code relating to displayed video.

37. The software meter of claim 36 wherein the second program code determines the ancillary identification code from a device driver.

38. The software meter of claim 37 wherein the device driver is a device driver for a video tuning card.

39. The software meter of claim 36 further comprising third program code arranged to determine a program and/or station from an electronic programming guide based upon the tuning data.

40. The software meter of claim 36 wherein the first program code is arranged to (i) determine whether the viewing device has a COM interface or an API interface, (ii) determine channel data from a channel related object of a COM interface if the viewing device has the COM interface, and (iii) determine channel data from application related data associated with a video application if the viewing device has an API interface.

41. The software meter of claim 40 wherein the first program code is arranged to determine channel data from window text if the viewing device has neither a COM interface nor an API interface.

42. The software meter of claim 41 further comprising third program code arranged to determine a program and/or station from an electronic programming guide based upon the tuning data.

43. The software meter of claim 41 wherein the first program code is arranged to (i) find main windows, (ii) find a video application main window from the main windows, (iii) find child windows of the video application main window, (iv) find a channel related child window from the child windows, and (v) determine channel data from the channel related child window.

44. The software meter of claim 43 wherein the first program code is arranged to use a callback function in order to find the video application main window from the main windows.

45. The software meter of claim 43 wherein the first program code is arranged to use a callback function to find the channel related child window.

46. The software meter of claim 43 further comprising third program code arranged to determine a program and/or station from an electronic programming guide based upon the tuning data.

47. The software meter of claim 36 wherein the software meter is written in Java.

48. A metering system for metering viewing of video displayed in a window on a screen of a viewing device comprising:
a software meter arranged to determine identifying data related to the video displayed in the window; and,
a creditor arranged to apply a crediting rule in determining whether to credit the identifying data.

49. The metering system of claim 48 wherein the crediting rules comprises minimization, and wherein the creditor comprises program code to credit the identifying data only if the viewing window is not minimized.

50. The metering system of claim 48 wherein the crediting rules comprises minimum window size, and wherein the creditor comprises program code to credit the identifying data only if the size of the viewing window is greater than the minimum window size.

51. The metering system of claim 48 wherein the crediting rules comprises an amount of occlusion of the viewing window, and wherein the creditor comprises program code to credit the identifying data only if the amount of occlusion of the viewing window is less than a maximum occlusion.

52. The metering system of claim 48 wherein the crediting rules comprises a percentage of the screen occupied by the viewing window, and wherein the creditor comprises program code to credit the identifying data only if the percentage of the screen occupied by the viewing window is greater than a minimum percentage.

53. The metering system of claim 48 wherein the viewing window is a first viewing window, wherein a second viewing window is displayed on the screen, wherein audio is being played with respect to one of the first and second viewing windows, and wherein the creditor comprises program code to credit the identifying data only with respect to the one of the first and second viewing windows associated with the audio.

54. The metering system of claim 48 wherein the viewing window is a first viewing window, wherein a second viewing window is displayed on the screen, wherein one of the first and second viewing windows is a larger viewing window, and wherein the creditor comprises program code to credit the identifying data only with respect to the larger viewing window.

55. The metering system of claim 48 wherein the viewing window is a first viewing window, wherein a second viewing window is displayed on the screen, wherein one of the first and second viewing windows is a top-most viewing window, and wherein the creditor comprises program code to credit the identifying data only with respect to the topmost viewing window.

56. The metering system of claim 48 wherein the crediting rules comprises minimization and minimum window size, and wherein the creditor comprises program code to credit the identifying data only if the viewing window is not minimized and the size of the viewing window is greater than the minimum window size.

57. The metering system of claim 48 wherein the crediting rules comprises minimization and an amount of occlusion of the viewing window, and wherein the creditor comprises program code to credit the identifying data only if the viewing window is not minimized and the amount of occlusion of the viewing window is less than a maximum occlusion.

58. The metering system of claim 48 wherein the crediting rules comprises minimization and a percentage of the screen occupied by the viewing window, and wherein the creditor comprises program code to credit the identifying data only if the viewing window is not minimized and the percentage of the screen occupied by the viewing window is greater than a minimum percentage.

59. The metering system of claim 48 wherein the crediting rules comprises minimum window size and an amount of occlusion of the viewing window, and wherein the creditor comprises program code to credit the identifying data only if the size of the viewing window is greater than the minimum window size and the amount of occlusion of the viewing window is less than a maximum occlusion.

60. The metering system of claim 48 wherein the crediting rules comprises minimum window size and a percentage of the screen occupied by the viewing window, and wherein the creditor comprises program code to credit the identifying data only if the size of the viewing window is greater than the minimum window size and the percentage of the screen occupied by the viewing window is greater than a minimum percentage.

61. The metering system of claim 48 wherein the crediting rules comprises an amount of occlusion of the viewing window and a percentage of the screen occupied by the viewing window, and wherein the creditor comprises program code to credit the identifying data only if the amount of occlusion of the viewing window is less than a maximum occlusion and the percentage of the screen occupied by the viewing window is greater than a minimum percentage.

62. The metering system of claim 48 wherein the crediting rules comprises minimization, minimum window size, and an amount of occlusion of the viewing window, and wherein the creditor comprises program code to credit the identifying data only if the viewing window is not minimized and the size of the viewing window is greater than the minimum window size and the amount of occlusion of the viewing window is less than a maximum occlusion.

63. The metering system of claim 48 wherein the crediting rules comprises minimization, minimum window size, and a percentage of the screen occupied by the viewing window, and wherein the creditor comprises program code to credit the identifying data only if the viewing window is not minimized and the size of the viewing window is greater than the minimum window size and the percentage of the screen occupied by the viewing window is greater than a minimum percentage.

64. The metering system of claim 48 wherein the crediting rules comprises minimum window size, an amount of occlusion of the viewing window, and a percentage of the screen occupied by the viewing window, and wherein the creditor comprises program code to credit the identifying data only if the size of the viewing window is greater than the minimum window size and the amount of occlusion of the viewing window is less than a maximum occlusion and the percentage of the screen occupied by the viewing window is greater than a minimum percentage.

65. The metering system of claim 48 wherein the predetermined crediting rule applied in step a) comprises minimization, an amount of occlusion of the viewing window, and a percentage of the screen occupied by the viewing window, and wherein step b) comprises the step of crediting viewing with respect to the viewing window only if the viewing window is not minimized and the amount of occlusion of the viewing window is less than a maximum occlusion and the percentage of the screen occupied by the viewing window is greater than a minimum percentage.

66. The metering system of claim 48 wherein the crediting rules comprises minimization, minimum window size, an amount of occlusion of the viewing window, and a percentage of the screen occupied by the viewing window, and wherein the creditor comprises program code to credit the identifying data only if the viewing window is not minimized and the size of the viewing window is greater than the minimum window size and the amount of occlusion of the viewing window is less than a maximum occlusion and the percentage of the screen occupied by the viewing window is greater than a minimum percentage.

67. The metering system of claim 48 wherein the software meter has first program code to determine whether the viewing device has a COM interface or an API interface and second program code to determine channel data from a channel related object of the COM interface or from application related data associated with a video application through the API interface.

68. The metering system of claim 67 wherein the software meter has third program code to determine a program and/or station from an electronic programming guide based upon the channel data.

69. The metering system of claim 67 wherein the software meter has third program code to determine channel data from window text if the viewing device has neither a COM interface nor an API interface.

70. The metering system of claim 69 wherein the software meter has fourth program code to determine a program and/or station from an electronic programming guide based upon the channel data.

71. The metering system of claim 69 wherein the software meter has fourth program code to find main windows, wherein the software meter has fifth program code to find a video application main window from the main windows, wherein the software meter has sixth program code to find child windows of the video application main window, wherein the software meter has seventh program code to find a channel related child window from the child windows, and wherein the software meter has eighth program code to determine channel data from the channel related child window.

72. The metering system of claim 71 wherein the fourth program code uses a callback function to find the video application main window from the main windows.

73. The metering system of claim 71 wherein the sixth program code uses a callback function to find the channel related child window.

74. The metering system of claim 71 wherein the software meter has ninth program code to determine a program and/or station from an electronic programming guide based upon the channel data.

75. The metering system of claim 48 wherein the software meter comprises:
a) first program code executable to determine tuning data from a video application related to the displayed video; and,
b) second program code executable to determine an ancillary identification code relating to displayed video.

76. The metering system of claim 75 wherein the second program code determines the ancillary identification code from a device driver.

77. The metering system of claim 76 wherein the device driver is a device driver for a video tuning card.

78. The metering system of claim 75 comprising third program code arranged to determine a program and/or station from an electronic programming guide based upon the tuning data.

79. The metering system of claim 75 wherein the first program code is arranged to (i) determine whether the viewing device has a COM interface or an API interface, (ii) determine channel data from a channel related object of a COM interface if the viewing device has the COM interface, and (iii) determine channel data from application related data associated with a video application if the viewing device has an API interface.

80. The metering system of claim 79 wherein the first program code is arranged to determine channel data from window text if the viewing device has neither a COM interface nor an API interface.

81. The metering system of claim 80 comprising third program code arranged to determine a program and/or station from an electronic programming guide based upon the tuning data.

82. The metering system of claim 80 wherein the first program code is arranged to (i) find main windows, (ii) find a video application main window from the main windows, (iii) find child windows of the video application main window, (iv) find a channel related child window from the child windows, and (v) determine channel data from the channel related child window.

83. The metering system of claim 82 wherein the first program code is arranged to use a callback function in order to find the video application main window from the main windows.

84. The metering system of claim 82 wherein the first program code is arranged to use a callback function to find the channel related child window.

85. The metering system of claim 82 comprising third program code arranged to determine a program and/or station from an electronic programming guide based upon the tuning data.

86. The metering system of claim 48 wherein the software meter is written in Java.

87. The metering system of claim 48 wherein the creditor rule is at least partially located at a panelist site.

88. The metering system of claim 48 wherein the creditor is at least partially located at a site remote from a panelist site.

89. The metering system of claim 48 wherein a first portion of the creditor is located at a panelist site, and wherein a second portion of the creditor is located at a site remote from the panelist site.
